(19) United States
(12) Patent Application Publication
(10) Pub. No.: US 2020/0047489 A1
(43) Pub. Date: Feb. 13, 2020

(54) LIQUID EJECTING DEVICE AND LIQUID EJECTING METHOD

(71) Applicant: MIMAKI ENGINEERING CO., LTD., Nagano (JP)

(72) Inventors: Wataru HIOKI, Nagano (JP); Chika Furuya, Nagano (JP)

(73) Assignee: MIMAKI ENGINEERING CO., LTD., Nagano (JP)

(21) Appl. No.: 16/521,594

(22) Filed: Jul. 25, 2019

(30) Foreign Application Priority Data
Aug. 10, 2018 (JP) 2018-151362

(51) Int. Cl. B41J 2/045

(52) U.S. Cl. CPC B41J 2/0451; B41J 2/04586

(57) ABSTRACT

A printing apparatus operating as a liquid ejecting device is provided and includes: an inkjet head including a plurality of nozzles, a scanning driver that causes the inkjet head to perform a main scan, and a controller. When an abnormal nozzle is present, the controller causes another nozzle in the vicinity of the abnormal nozzle to eject the liquid of a larger amount than that in a normal time to a part of an ejecting position where the liquid can be ejected by the other nozzle based on a mask prepared in advance, so that an amount of liquid to be ejected at the time of the main scanning direction by the other nozzle becomes larger than that in the normal time. The mask is data specifying the ejecting position to increase an ejection amount of the liquid and an ejection amount to be increased at the ejecting position.

### CROSS REFERENCE TO RELATED APPLICATIONS

This application claims the priority benefit of Japanese Patent Application No. 2018-151362, filed on Aug. 10, 2018. The entirety of the above-mentioned patent application is hereby incorporated by reference herein and made a part of this specification.

### TECHNICAL FIELD

The present disclosure relates to a liquid ejecting device and a liquid ejecting method.

### DESCRIPTION OF THE BACKGROUND ART

Various methods have been conventionally proposed for an inkjet recording apparatus to suppress degradation of image quality caused by ejection failure of an ink from a nozzle (see e.g., Japanese Unexamined Patent Publication No. 2015-130166, Patent Literature 1). For example, Japanese Unexamined Patent Publication No. 2015-130166 discloses a method of complementary control in which complementary ejection is performed by a nearby nozzle, so as to compensate for the amount of ink dot that is not ejected by a defective nozzle.
Patent Literature 1: Japanese Unexamined Patent Publication No. 2015-130166

### SUMMARY

In the complementary control disclosed in the configuration of Japanese Unexamined Patent Publication No. 2015-130166, when there is amount of misalignment between the amount of ink which is not ejected in one recording operation and the change amount in the amount of ejection ink by the nearby nozzle, the amount of misalignment is added to the amount of ink which is not ejected to define the change amount in the amount of ejection ink in the complementary ejection in the complementary control related to the recording operation to be performed next. However, when complementary control is performed in this manner, a problem arises in that the required calculation amount increases in the calculation of the amount of misalignment, the process of determining the change amount in the amount of ejection ink in the complementary ejection by adding the amount of misalignment, and the like. In addition, as a result, the time required for the calculation becomes long, which may affect the printing speed. Furthermore, in a case where a configuration capable of high-speed calculation is used, the cost of the device may greatly rise. Therefore, conventionally, it has been desired that in a case in which an abnormal nozzle whose ejection characteristic is deviated from a normal range, is present, the influence of the presence of the abnormal nozzle is suppressed more appropriately. The present disclosure thus provides a liquid ejecting device and a liquid ejecting method capable of overcoming such problem.

The inventors of the present application conducted intensive research on a method of recovery process, which is a process for suppressing the influence of the presence of an abnormal nozzle when an abnormal nozzle is present. Then, in a case where ink is ejected by another normal nozzle instead of the abnormal nozzle, consideration is made to determine the ejecting position and the amount of ink using a mask. With this configuration, for example, the recovery process can be executed without performing many operations and the like.

Here, in this regard, in the conventional recovery process, as in the method disclosed in, for example, Japanese Unexamined Patent Publication No. 2015-130166, it is considered important to accurately match the amount of ink ejected by another normal nozzle instead of the abnormal nozzle with the original ejection amount by the abnormal nozzle as much as possible. In this case, the original ejection amount by the abnormal nozzle is the amount of ink ejected when the abnormal nozzle is normal.

On the other hand, in a case where the recovery process is performed using a mask, the recovery process is not configured to be accurately performed in accordance with the original ejection amount of the abnormal nozzle due to the configuration using a mask prepared in advance. However, the inventors of the present application found that the recovery process can be appropriately performed even by a method using a mask in practice by actually performing various experiments and the like. In addition, the inventors found that particularly when ink dots widely spread to a certain extent or more on a medium to be printed (medium) such as a case of printing on a cloth, for example, the recovery process can be simply and appropriately performed with high accuracy by using a mask.

Furthermore, the inventors of the present application found the features necessary for obtaining such effects through further intensive research, and have contrived the present disclosure. In order to solve the above-described problems, the present disclosure provides a liquid ejecting device that ejects a liquid through an inkjet method, and the liquid ejecting device includes: an inkjet head including a plurality of nozzles arranged with positions shifted from each other in a nozzle row direction that is predetermined; a scanning driver that causes the inkjet head to perform a main scan of ejecting the liquid while relatively moving in a main scanning direction intersecting the nozzle row direction to an liquid ejecting target; and a controller that controls operation of the inkjet head and the scanning driver. When an abnormal nozzle which is a nozzle having an abnormal ejection characteristic is present, the controller causes another nozzle in a vicinity of the abnormal nozzle to eject the liquid of a larger amount than that in a normal time when the abnormal nozzle is not present to a part of an ejecting position where the liquid can be ejected by the other nozzle in the main scan based on a mask prepared in advance, so that an amount of the liquid to be ejected at a time of the main scan by the other nozzle becomes larger than that in the normal time, and the mask is data specifying the ejecting position for increasing an ejection amount of the liquid and an ejection amount to be increased at the ejecting position.

In this configuration, the liquid ejecting device is, for example, a printing apparatus. Furthermore, in this case, the liquid ejecting target is a medium to be printed. Moreover, the liquid ejected from the inkjet head is, for example, ink. The inkjet head is, for example, an ejection head that ejects liquid through an inkjet method.

When configured in this manner, the ink can be ejected by another nozzle instead of the abnormal nozzle by increasing the ejection amount of the other nozzles. Thus, the recovery process can be appropriately performed in a case in which an abnormal nozzle is present. Furthermore, in this case, the recovery process can be easily and appropriately performed without performing many calculations, and the like by specifying the ejecting position to increase the ejection amount of ink by other nozzles and the ejection amount (increase amount of liquid) to be increased at such an ejecting position in the mask. Therefore, if configured in this way, for example, when an abnormal nozzle is present, the influence of the presence of the abnormal nozzle can be appropriately suppressed.

Furthermore, in this configuration, when the abnormal nozzle is present, in the main scan, the controller does not cause the abnormal nozzle to eject the liquid and causes the other nozzle to eject the liquid of the larger amount than that in the normal time to the part of the ejecting position where the liquid can be ejected by the other nozzle. With this configuration, the influence of the abnormal nozzle can be more appropriately suppressed. Moreover, in this configuration, it is conceivable to use, for example, an inkjet head in which the volume of the liquid ejected from the nozzle can be changed in a plurality of stages as the inkjet head. Furthermore, in this case, the mask specifies, for example, a number of stages for increasing the ejection amount as the ejection amount to be increased at the ejecting position for increasing the ejection amount of the liquid. According to this configuration, for example, the volume of the liquid to be ejected can be made larger than the normal time for the ejecting position (e.g., a part of ejecting position) where the liquid is ejected by another nozzle in the vicinity of the abnormal nozzle by increasing the ejection amount according to the number of stages specified by the mask.

More specifically, in this case, it is conceivable to use at least an adjacent nozzle adjacent to the abnormal nozzle in the nozzle row direction as another nozzle in a vicinity of the abnormal nozzle. Furthermore, for example, it is conceivable to specify in the mask the ejecting position for increasing the ejection amount of the liquid and the number of stages for increasing the ejection amount for a preset number of ejecting positions aligned in the main scanning direction. When the abnormal nozzle is present, it is conceivable that the controller periodically applies the mask for every preset number to an arrangement of ejecting positions for ejecting the liquid by the nozzle adjacent to the abnormal nozzle. According to such a configuration, for example, it is possible to cause the adjacent nozzle to eject the liquid of the larger amount than that in the normal time to the part of the ejecting position where the liquid can be ejected by the nozzle adjacent to the abnormal nozzle at the time of the main scan. Furthermore, for example, the recovery process using a mask can be appropriately performed.

Further, in this case, it is preferable to increase the ejection amount of the liquid by the nozzle adjacent to the abnormal nozzle only with respect to the ejecting position adjacent to the original ejecting position by the abnormal nozzle. In this case, the original ejecting position by the abnormal nozzle is the position at which the liquid should be ejected when the abnormal nozzle is a normal nozzle. More specifically, when the abnormal nozzle is present, for example, among the ejecting positions where the liquid is to be ejected by the nozzle adjacent to the abnormal nozzle, the controller increases an amount of the liquid to be ejected than that in the normal time based on the mask, only with respect to an ejecting position adjacent in the nozzle row direction and only with respect to an ejecting position where the liquid is ejected when the abnormal nozzle is a normal nozzle. In this case, the amount of ink to be ejected is not changed even if it is specified to increase the amount of liquid in the mask with respect to the ejecting position adjacent in the nozzle row direction to the ejecting position where liquid is not ejected even when the abnormal nozzle is a normal nozzle. With this configuration, for example, the recovery process can be performed according to the number of original ejecting positions of the abnormal nozzle. In addition, for example, excessive recovery process can be appropriately prevented from being carried out. Moreover, for example, when the liquid ejecting device is a printing apparatus, the recovery process corresponding to the image to be printed can be more appropriately performed.

Furthermore, in this configuration, for example, it is conceivable to execute the recovery process by correcting a raster image indicating the ejecting position of the liquid. In this case, the raster image indicating the ejecting position of the liquid is, for example, a raster image generated by the RIP process. More specifically, in this case, the controller causes each of the nozzles of the inkjet head to eject the liquid based on, for example, a raster image indicating the ejecting position of the liquid. Then, when the abnormal nozzle is present, for example, the controller corrects the raster image based on the mask, and causes each of the nozzles to eject the liquid based on the corrected raster image. According to this configuration, for example, the controller causes the other nozzle to eject the liquid of a larger amount than that in the normal time to the part of the ejecting position where the liquid can be ejected by the other nozzle in the vicinity of the abnormal nozzle at the time of the main scan. Furthermore, for example, the recovery process using the mask can be appropriately performed.

As a recovery process when an abnormal nozzle is present, a recovery process using an operation through a multi-pass method, and the like has been widely performed conventionally. In this case, the multi-pass method is, for example, a method in which the main scan is performed such that a plurality of main scans are performed with respect to each position of a liquid ejecting target. In this case, the sub scan for moving the inkjet head relative to the liquid ejecting target in the sub scanning direction orthogonal to the main scanning direction is performed between the main scans so that the nozzle capable of ejecting liquid to one position can be differed for each main scan. Therefore, even when an abnormal nozzle is present, the recovery process can be performed by an alternative process of ejecting liquid using another nozzle in another main scan with respect to the ejecting position corresponding to the abnormal nozzle in each main scan.

However, in the case of the configuration (one-pass configuration) in which only one main scan is performed for each position of the liquid ejecting target, the recovery process by such a method cannot be performed. On the other hand, when configured as described above, the recovery process can be performed in one main scan by using a nozzle in the vicinity of the abnormal nozzle. Therefore, the recovery process using the mask as described above can be particularly suitably used when only one main scan is performed for each position of the liquid ejecting target. Furthermore, in this case, the scanning driver causes the inkjet head to perform the main scan such that, for example, one main scan is performed with respect to each position of the liquid ejecting target.

Furthermore, in this configuration, for example, a printing apparatus using a cloth medium as a liquid ejecting target can be suitably used as the liquid ejecting device. In this case, the liquid ejected from the inkjet head is an ink used for printing. In this case as well, the ink is preferably ejected from the inkjet head so that an ink dot, which is large to a certain extent, is formed in the main scan. More specifically, in this case, for example, the inkjet head ejects ink from the respective nozzles so that ink dots formed on the medium by the ink ejected from the nozzle adjacent in the nozzle row direction have a size of making contact on the medium. With this configuration, for example, the effect of the recovery process performed using a mask can be appropriately enhanced. Furthermore, the recovery process performed using a mask can be more effectively performed.

In addition, for example, it is conceivable to use a sublimation transfer ink as the liquid to be ejected by the liquid ejecting device. In this case, the sublimation transfer ink is a sublimation ink used for transfer. Furthermore, in this case, it is conceivable to use a printing apparatus using a transfer medium as an ejecting target of sublimation transfer ink as the liquid ejecting device. In this case, since the ink dots spread during sublimation transfer of transferring the image from the transfer medium to another medium, the ink dots constituting the image after transfer, which becomes the final product, tend to be large dots. Therefore, even in such a case, the effect of the recovery process performed using the mask can be appropriately enhanced.

Furthermore, for example, it is conceivable to use an ultraviolet-curable ink or the like that is cured by irradiation of an ultraviolet light as the liquid to be ejected by the liquid ejecting device. In this case, it is particularly preferable to carry out the recovery process in the same main scan. More specifically, for example, when the operation of ejecting the liquid in place of the abnormal nozzle is performed in another main scan, as in the recovery process performed using the operation through the multi-pass method, a change also occurs in the timing at which the liquid lands. In the case of using the ultraviolet-curable ink, when a change occurs in the landing timing, an unintended stripe or the like may be generated due to an influence that a difference occurs in the curing timing between the ultraviolet-curable ink and the surrounding ink. Thus, in the case where the ultraviolet-curable ink is used, for example, even if the printing operation itself is performed by the multi-pass method, the recovery process is preferably performed in the same main scan. As a result, it can be said particularly preferable to perform the recovery process using the mask as described above in the case where the ultraviolet-curable ink is used as well.

Further, in the case of printing an image or the like, to what extent it is preferable to perform the recovery process may be different depending on the printing conditions or the image to be printed. Therefore, it is conceivable to prepare a plurality of masks in advance and to select the mask according to the printing conditions and the image to be printed. More specifically, in this case, the liquid ejecting device further includes, for example, a mask storage that stores a plurality of masks different from each other. Then, when the abnormal nozzle is present, for example, the controller causes the other nozzle to eject the liquid of a larger amount than that in the normal time to a part of an ejecting position where the liquid can be ejected by the other nozzle in the vicinity of the abnormal nozzle at the time of the main scan based on any of the masks selected from the plurality of masks. With this configuration, for example, the recovery process performed using a mask can be more appropriately performed.

Moreover, in this case, it is conceivable to use, for example, masks having different correction intensities as the plurality of masks. In this case, the difference in correction intensity means that, for example, the amounts of ink to be increased with respect to other nozzles in the vicinity of the abnormal nozzle are different from each other. In this case, the mask selection may be performed automatically or manually by a user.

Furthermore, when a printing apparatus for printing an image is used as a liquid ejecting device, it is conceivable that, for example, a plurality of masks each associated with different image densities are stored in the mask storage. In this case, the image density is, for example, the color strength in the image to be printed. The image density can also be considered as, for example, a concentration corresponding to the density of ink (liquid) dots formed on the medium at the time of printing. Then, when the abnormal nozzle is present, the controller selects any of the masks from the plurality of masks based on the image density of an image to be printed. Then, the other nozzle is caused to eject the liquid of a larger amount than that in the normal time to a part of the ejecting position where the liquid can be ejected by the other nozzle in the vicinity of the abnormal nozzle at the time of the main scan based on the selected mask. With this configuration, for example, the recovery process can be more appropriately performed in accordance with the image to be printed.

Use of a liquid ejecting method having the features similar to the above, and the like can be considered for the configuration of the present disclosure. In this case as well, for example, effects similar to the above can be obtained.

According to the present disclosure, for example, the influence of the presence of an abnormal nozzle can be more appropriately suppressed.

### BRIEF DESCRIPTION OF THE DRAWINGS

FIGS. 1A and 1B are views describing a printing apparatus 10 according to one embodiment of the present disclosure. FIG. 1A shows one example of a configuration of a main part of the printing apparatus 10. FIG. 1B shows one example of a configuration of a head portion 12 in the printing apparatus 10.

FIGS. 2A to 2D are views describing a recovery process performed in the present example. FIG. 2A shows an example of a volume of ink that can be ejected from the nozzles in the inkjet head 102 for each color. FIGS. 2B to 2D are views specifically showing an example of the recovery process performed in the present example.

FIGS. 3A and 3B are views describing the size of ink dots in more detail. FIG. 3A is a view showing an example of a size of the ink dot. FIG. 3B shows an example of the arrangement of ink dots formed when the recovery process is performed.

FIGS. 4A to 4C are views describing the recovery process performed in the present example in more detail. FIG. 4A shows an example of a mask used in the recovery process of the present example. FIGS. 4B and 4C show an example of the application result of a mask.

FIG. 5 is a flowchart showing an example of a printing operation performed by the printing apparatus 10.

### DESCRIPTION OF EMBODIMENTS

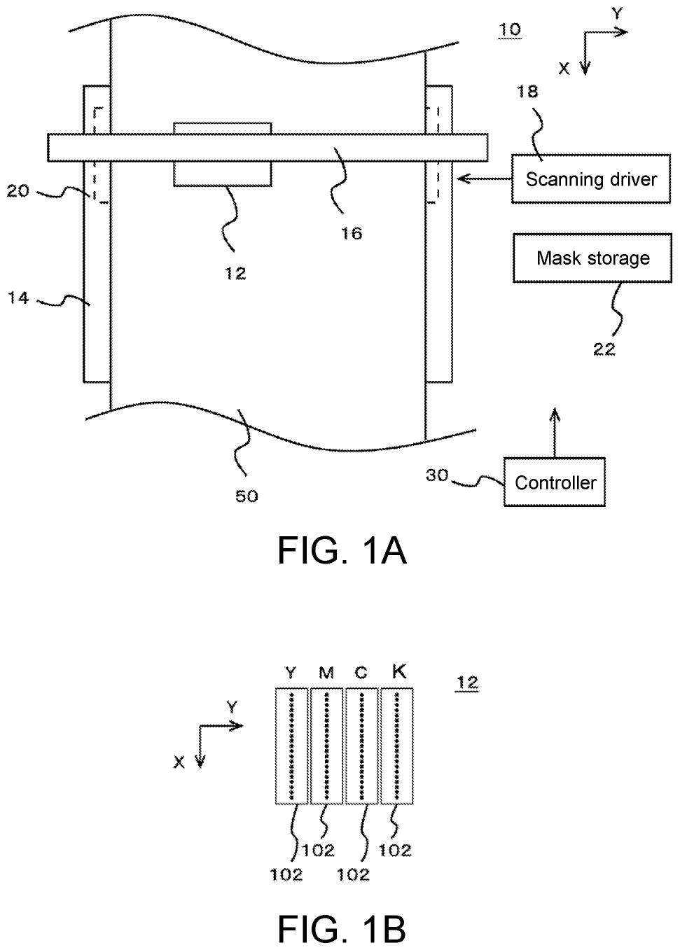

Hereinafter, an embodiment according to the present disclosure will be described with reference to the drawings. FIGS. 1A and 1B are views describing a printing apparatus 10 according to one embodiment of the present disclosure. FIG. 1A shows one example of a configuration of a main part of the printing apparatus 10. FIG. 1B shows one example of a configuration of a head portion 12 in the printing apparatus 10. Note that, except for the points described below, the printing apparatus 10 may have features same as or similar to the known inkjet printers. For example, the printing apparatus 10 may further have a configuration same as or similar to a known inkjet printer, in addition to the configuration described below.

The printing apparatus 10 is an example of a liquid ejecting device that ejects liquid through an inkjet method, and performs printing through the inkjet method on a medium 50 to be printed (medium). In this case, the medium 50 is an example of an ink ejecting target. Furthermore, the ink is, for example, liquid ejected from an inkjet head. The inkjet head is, for example, an ejection head that ejects liquid through an inkjet method. The ink can also be considered as, for example, a functional liquid or the like ejected by a liquid ejecting device. More specifically, in the present example, the printing apparatus 10 is an inkjet printer (textile printer) that uses the cloth medium 50 as an ink ejecting target, and includes a head portion 12, a platen 14, a guide rail 16, a heater 20, a scanning driver 18, a mask storage 22, and a controller 30. The cloth medium 50 is, for example, fabric, various types of cloth products and the like. As the cloth medium 50, for example, a medium 50 same as or similar to the medium 50 used as a printing target in a known textile printer can be suitably used.

The head portion 12 is a portion that ejects the ink to the medium 50, and for example, includes a plurality of inkjet heads 102, as shown in FIG. 1B. In this case, each inkjet head 102 is an inkjet head that ejects the ink of each color used for printing. Each of the plurality of inkjet heads 102 includes a nozzle row in which a plurality of nozzles for ejecting ink onto the medium 50 are arranged, and ejects inks having different colors from each other. Furthermore, the plurality of nozzles in each of the inkjet heads 102 are arranged with their positions shifted from one another in a nozzle row direction that is predetermined. When referring to arranging with their positions shifted from one another in a nozzle row direction, this means, for example, that the positions are shifted from one another when focusing only on the positions in the nozzle row direction and ignoring the positions in a direction orthogonal to the nozzle row direction. More specifically, in the present example, the nozzle row direction is a direction parallel to the sub scanning direction (X direction in FIG. 1B) set in advance in the printing apparatus 10. Furthermore, in each of the inkjet heads 102, the plurality of nozzles form a nozzle row by being arranged so that the intervals in the sub scanning direction become constant.

In the present example, the head portion 12 includes the plurality of inkjet heads 102, each of which ejects ink of each color of yellow (Y), magenta (M), cyan (C), and black (K). As shown in FIG. 1B, the plurality of inkjet heads 102 are arranged side by side in a main scanning direction (Y direction in FIG. 1B) orthogonal to the sub scanning direction with the positions in the sub scanning direction aligned. In this case, the main scanning direction is an example of a direction intersecting the nozzle row. Furthermore, in the head portion 12, for example, a plurality of inkjet heads 102 are held by a carriage (not shown). Moreover, in the present example, an evaporation-drying type ink which is an ink that fixes to the medium 50 by evaporating the solvent is used as the ink of each color. In addition, as the inkjet head 102 for each color, an inkjet head that can change the volume of ink to be ejected from a nozzle in a plurality of stages is used. The feature that the volume of ink can be changed will be described in more detail later.

The platen 14 is a table-shaped member that supports the medium 50 at a position facing the head portion 12. The guide rail 16 is a rail-like member extending in the main scanning direction, and guides the movement of the head portion 12 in the main scanning direction. The heater 20 is a heating device for evaporating the solvent in the ink. In the present embodiment, the heater 20 is disposed in the platen 14 at a position facing the head portion 12 with the medium 50 therebetween, and volatilizes and removes the solvent in the ink by heating the medium 50.

The scanning driver 18 is a driver that causes the head portion 12 to perform a scanning operation of relatively moving with respect to the medium 50. In this case, causing the head portion 12 to perform a scanning operation means, for example, causing the respective inkjet heads 102 of the head portion 12 to perform a scanning operation. Furthermore, in the present example, the scanning driver 18 causes the head portion 12 to perform the main scan and the sub scan. In this case, the main scan is, for example, an operation (scanning operation) of ejecting ink while moving in the main scanning direction. Furthermore, at the time of the main scan, the scanning driver 18 moves the head portion 12 along the guide rail 16. Moreover, regarding the main scan, the movement of the head portion 12 in the main scanning direction is a relative movement with respect to the medium 50. Therefore, in the modified example of the printing apparatus 10, the medium 50 side may be moved by fixing the position of the head portion 12, and moving the platen 14, for example.

Furthermore, the sub scan is, for example, an operation that moves relative to the medium 50 in the sub scanning direction. In the present example, the scanning driver 18 causes the head portion 12 to perform the sub scan by conveying the medium 50 in the conveyance direction parallel to the sub scanning direction using, for example, a roller (not shown). Furthermore, in this case, the medium 50 is conveyed by a preset feed amount between each main scan. Moreover, in the present example, the printing apparatus 10 executes the printing operation through the serial method by causing the head portion 12 to perform the main scan and the sub scan. In this case, the printing operation is performed by the one-pass operation of setting the pass number to one. The pass number is, for example, the number of main scans performed on the same position on the medium 50. Furthermore, the operation of one pass can be considered as, for example, an operation in a configuration in which only one main scan is performed with respect to each position of the medium 50.

The mask storage 22 is a storage device that stores a mask used in the recovery process. In this case, the recovery process is, for example, a process for suppressing the influence of the presence of an abnormal nozzle when an abnormal nozzle is present. Furthermore, the abnormal nozzle is a nozzle whose ejection characteristic is abnormal. Moreover, the abnormal nozzle can also be considered as, for example, a nozzle whose ejection characteristic is deviated from a preset normal range. In addition, in the present example, the mask storage 22 stores a plurality of masks different from each other. The recovery process performed using the mask will be described in more detail later.

The controller 30 is, for example, a CPU of the printing apparatus 10, and controls the operation of each portion of the printing apparatus 10. More specifically, the printing apparatus 10 causes each nozzle in the head portion 12 to eject ink according to an image to be printed, for example, at the time of control of the main scan by the head portion 12. Furthermore, as will be described in more detail later, in the present example, the printing apparatus 10 further performs control of recovery process and the like performed using a mask. According to this example, for example, various images can be appropriately printed by the printing apparatus 10.

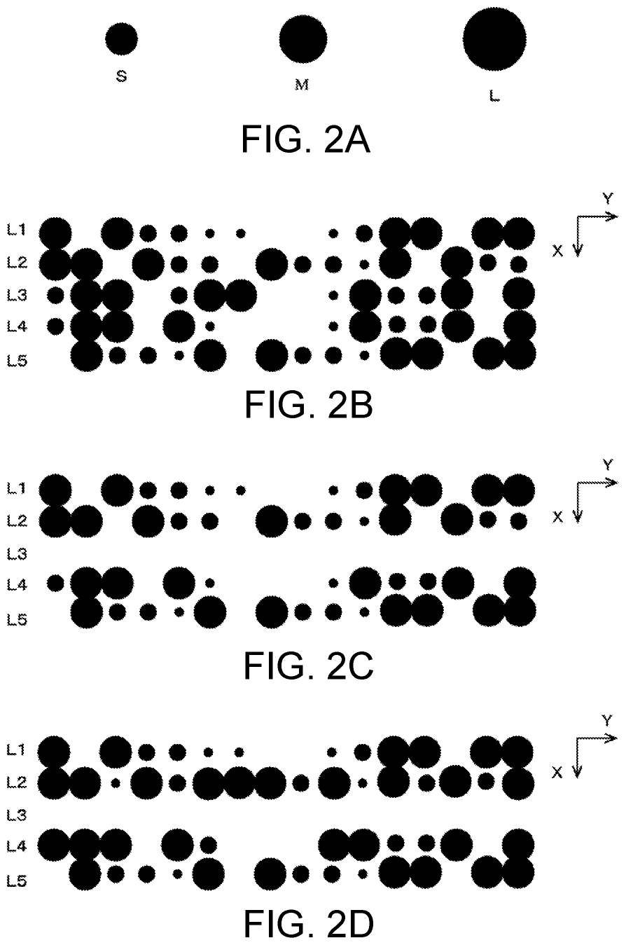

Subsequently, the recovery process performed in the present example will be described. FIGS. 2A to 2D are views describing the recovery process performed in the present example. FIG. 2A shows one example of the volume of ink that can be ejected from the nozzles in the inkjet head 102 (see FIG. 1B) for each color. As described above, in the present example, an inkjet head capable of changing the volume of the ink to be ejected from the nozzle in a plurality of stages is used as the inkjet head 102 for each color. More specifically, in the present example, the inkjet head 102 can eject the ink from each of the nozzles with three types of volumes of S (small), M (medium), and L (large) as shown in FIG. 2A. In this case, four types of values (four values) can be represented by one nozzle by including a state in which ink is not ejected from the nozzle. Furthermore, as such an inkjet head 102, a known inkjet head (multi-valued head) in which the volume of ink can be varied in a plurality of stages can be suitably used.

Furthermore, in the present example, the recovery process is performed using such a feature that the volume of ink can be changed. More specifically, when one of the nozzles in any one of the inkjet heads 102 is an abnormal nozzle, the controller 30 (see FIG. 1A) controls the operation of the scanning driver 18 (see FIG. 1A) so that the main scan is performed without using the abnormal nozzle. In this case, any other nozzle other than the abnormal nozzle is caused to eject an amount of ink larger than that in the normal time when the abnormal nozzle is not present, thereby suppressing the influence that may occur when the abnormal noise is caused not to eject ink. According to such a configuration, for example, the ink can be ejected by the other nozzles in place of the abnormal nozzle by increasing the ejection amount of the other nozzles other than the abnormal nozzle. Thus, the recovery process can be appropriately performed in a case in which an abnormal nozzle is present.

FIGS. 2B to 2D are views specifically showing an example of the recovery process performed in the present example. In FIGS. 2B to 2D, the ink dots are shown somewhat smaller in order to reduce the overlapping of the ink dots and to make it easy to identify the individual ink dots. The size of the ink dot will be described in more detail later.

Furthermore, among FIGS. 2B to 2D, FIG. 2B shows one example of the arrangement of ink dots formed at the normal time when an abnormal nozzle is not present. In FIG. 2B, the ink dots arranged in the main scanning direction (Y direction) are dots formed by one nozzle in one inkjet head 102. Furthermore, in this case, the arrangement of ink dots arranged in the main scanning direction can also be considered as dots formed by one nozzle in one main scan. In each main scan, each nozzle of each inkjet head 102 forms a plurality of ink dots arranged in the main scanning direction by ejecting ink to an ejecting position set in advance according to the image to be printed. In this case, the ink of any one volume of S, M, or L is ejected to each ejecting position where the ink is to be ejected. Furthermore, in FIG. 2B, characters L1 to L5 indicate five lines arranged in the sub scanning direction. In this case, a line is a line formed by a plurality of ink dots arranged in the main scanning direction. Moreover, as can be understood from the above description, in this case, each line corresponds to each of the five nozzles arranged continuously in the nozzle row direction parallel to the sub scanning direction (X direction).

Furthermore, FIG. 2C shows one example of the arrangement of ink dots formed when the recovery process is not performed when an abnormal nozzle is present. Moreover, in the illustrated case, an example of the arrangement of ink dots is shown for the case where the nozzle corresponding to the line denoted with the character L3 is a non-ejection nozzle that does not eject ink. In this case, as shown in FIG. 2C, a state in which the dots constituting the line denoted with the character L3 (hereinafter referred to as the line of L3) are removed from the arrangement of ink dots shown in FIG. 2B is obtained. Furthermore, in this case, as one line disappears, streaky portions (white stripes) in which the amount of ink runs short occurs in the printing result, and the printing quality may lower.

On the other hand, FIG. 2D shows one example of the arrangement of ink dots formed when the recovery process is performed. In this case as well, the line of L3 is not formed as in the case shown in FIG. 2C. However, in this case, for some lines other than the line of L3, the influence of the disappearance of the line of L3 is reduced by increasing the amount of ink constituting the line than in the normal time. More specifically, in the case shown in FIG. 2D, the volume of ink to be ejected to a part of ejecting position is made larger than the normal time for the line of L2 and the line of L4 (line denoted with L2 and L4 in FIG. 2D), which are lines adjacent to the line of L3. According to this configuration, for example, when an abnormal nozzle is present, the abnormal nozzle may not eject ink and the amount of ink ejected at the time of the main scan by the other nozzles in the vicinity of the abnormal nozzle can be made larger than that in the normal time. Thus, for example, the influence of the disappearance of the line of L3 can be reduced, and the recovery process can be appropriately performed.

Here, as described above, in FIGS. 2B to 2D, the ink dots are illustrated slightly smaller. Therefore, for example, in FIG. 2D, an impression may be given as if the effect of the recovery process is small. However, when the actual ink dot size is taken into consideration, the recovery process can be appropriately performed by performing as described above.

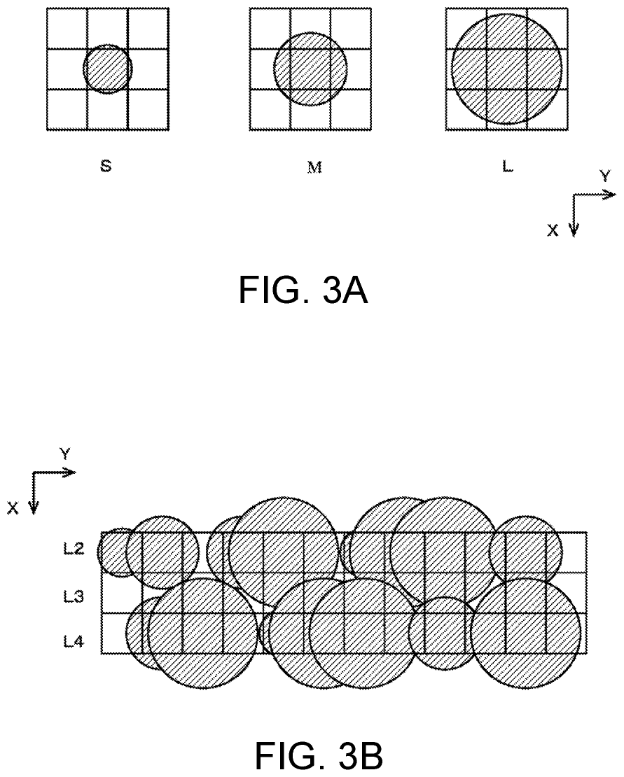

FIGS. 3A and 3B are views describing the size of ink dots in more detail. FIG. 3A is a view showing one example of the size of ink dots, and shows one example of the relationship between the resolution of printing and the ink dots of three types of sizes of S, M and L. In this case, the three types of sizes of S, M, and L refer to the sizes of ink dots formed by the respective volumes of three types of S, M, and L. The relationship with the resolution of printing, for example, is the relationship with the interval of the ejecting position set according to the resolution of printing. More specifically, in FIG. 3A, the nine squares shown in the background of ink dots of each size indicate an example of the ejecting positions set according to the resolution. Furthermore, among these squares, the central square indicates an ejecting position at which ink is ejected at the time of forming each dot. Moreover, squares other than the central square indicate the ejecting positions around the ejecting position corresponding to the central square. In addition, in the present example, as can be seen from the sizes of the dots shown in FIG. 3A, a dot having a size that comes into contact with the ink dot formed at the adjacent ejecting position is formed as the ink dot of each size. In this case, the adjacent ejecting position is, for example, an ejecting position adjacent in each of the main scanning direction and sub scanning direction.

As is apparent from the recovery process method described above with reference to FIG. 2D and the like, in the present example, it is important that at least dots of L size have a size that contacts the ink dot at the adjacent ejecting position in the sub scanning direction parallel to the nozzle row direction. Furthermore, in this case, it is preferable that the dots of M size and S size also have such a size. Moreover, in this case, the inkjet head 102 (see FIG. 1B) for each color, for example, ejects ink from the respective nozzles so that ink dots formed on the medium 50 by the ink ejected from the nozzle adjacent in the nozzle row direction have a size of making contact on the medium 50.

FIG. 3B is a view showing an example of the arrangement of ink dots formed when the recovery process is performed, and shows the result of performing the recovery process in a manner same as or similar to the case described with reference to FIG. 2D while reflecting the size of the ink dots shown in FIG. 3A. As shown in FIG. 3B, according to the present example, the recovery process can be appropriately performed when an abnormal nozzle is present.

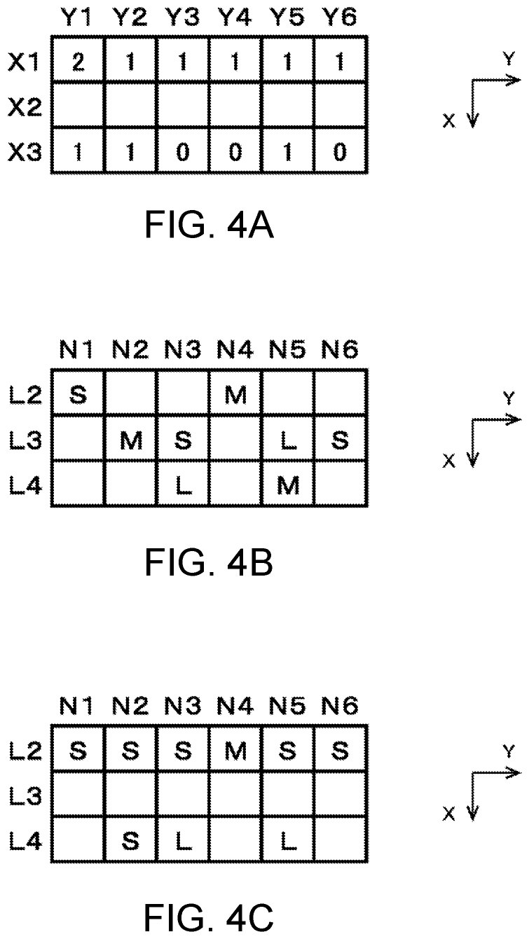

Now, the recovery process performed in the present example will be described in more detail. FIGS. 4A to 4C are views describing the recovery process performed in the present example in more detail. When the volume of ink ejected to a part of ejecting positions by nozzles other than the abnormal nozzle is made larger than that in the normal time as in the recovery process performed in the present example, ideally, the volume of ink is preferably changed so as to match as accurately as possible to the original ejection amount by the abnormal nozzle. The original ejection amount at the abnormal nozzle is the amount of ink ejected when the abnormal nozzle is normal. However, when the recovery process is performed in this manner, for example, the time required for the calculation may become long due to the increase in the required calculation amount, which may affect the printing speed. Furthermore, in a case where a configuration capable of high-speed calculation is used, the cost of the device may greatly rise. On the other hand, in the present example, in order to prevent the occurrence of such a problem, the recovery process is performed using the mask, as described above.

FIG. 4A shows an example of a mask used in the recovery process of the present example. As described above, in the present example, the recovery process is performed by changing the ejection amount of the ink by the other nozzles in the vicinity of the abnormal nozzle. Furthermore, in this case, at least a nozzle adjacent to the abnormal nozzle in the nozzle row direction is used as the other nozzles. More specifically, FIG. 4A illustrates an example of the mask in a case where the recovery process is performed using nozzles adjacent to the abnormal nozzle on both sides in the nozzle row direction. Furthermore, in FIG. 4A, characters X1 to X3 indicate three nozzles continuously arranged in the nozzle row direction. Moreover, among these, the central character X2 indicates an abnormal nozzle to be subjected to recovery process. The characters X1 and X3 indicate nozzles adjacent to the abnormal nozzle in the nozzle row direction.

Furthermore, in FIG. 4A, characters Y1 to Y6 indicate a plurality of ejecting positions continuously arranged in the main scanning direction. The plurality of ejecting positions that are continuously arranged in the main scanning direction are a plurality of ejecting positions that are continuously arranged, which are formed by ejecting ink by one nozzle in one main scan. Furthermore, the ejecting position formed by ejecting ink is a position to which the ink is ejected as needed according to the image to be printed. Moreover, as also described above, in the present example, the printing apparatus 10 (see FIG. 1A) executes the printing operation in a one-pass operation. In this case, it is conceivable that the characters Y1 to Y6 indicate a plurality of positions arranged in the main scanning direction at intervals corresponding to the printing resolution.

In this case, each of the squares aligned in a matrix indicates the ejecting position to which each nozzle ejects the ink at the time of the main scan. Furthermore, in FIG. 4A, the numbers in the squares indicate the ejection amount to be increased at each ejecting position as compared to the normal time with respect to the other nozzles (nozzles used for recovery) other than the abnormal nozzle. More specifically, in the present example, the number of stages for increasing the ejection amount is specified as the ejection amount to be increased at the ejecting position for increasing the ejection amount of the ink. In this case, the number of stages of the ejection amount is a number indicating the stages in the volume of ink of a plurality of stages that can be ejected from each nozzle.

More specifically, for example, at the ejecting position where the number 2 is specified, the volume of the ink to be ejected is increased by two stages. In this case, if the volume of the ink to be ejected at the ejecting position before application of the mask is the dot of S size (S dot), the volume of the ink is increased by two stages by the application of the mask to be set to the volume of the dot (L dot) of L size. Furthermore, in the case of an ejecting position where ink is not ejected before the application of the mask, the volume of the ink is increased by two stages by the application of the mask to be set to the volume of the dot of M size (M dot). Moreover, in the present example, if the ink volume exceeds the L dot when increased by two stages, the volume of ink after the application of the mask is set to the volume of L dot. Thus, when the volume of ink before the application of the mask is M dot or L dot, the volume of ink after the application of the mask is set to the volume of L dot.

In addition, for example, at the ejecting position where the number 1 is specified, the volume of the ink to be ejected is increased by one stage. In this case, if the volume of the ink before the application of the mask is the volume of S dot, the volume of ink after the application of the mask is set to the volume of M dot. When the volume of ink before the application of the mask is M dot or L dot, the volume of ink after the application of the mask is set to the volume of L dot. Furthermore, in the case of an ejecting position where ink is not ejected before the application of the mask, the volume of the ink is increased by one stage by the application of the mask to be set to the volume of S dot. Furthermore, the ejecting position where the number 0 is specified is an ejecting position where the volume of ink is not changed. In this case, the same volume as that before the application of the mask is set as the volume of ink after the application of the mask.

Furthermore, with regard to the matters described above in relation to the mask, the mask used in the present example, for example, can be considered as data specifying the ejecting position to increase the ejection amount of ink and the ejection amount to be increased at the ejecting position. In this case, the ejection amount to be increased at the ejecting position, for example, may be determined in consideration of the degree of influence on the ejecting position corresponding to the abnormal nozzle. In this case, the degree of influence on the ejecting position corresponding to the abnormal nozzle is the magnitude of influence determined according to the range covering the ejecting position of the abnormal nozzle, for example, when ink dots of various sizes are formed by the nozzles adjacent to the abnormal nozzle. Furthermore, as shown in FIG. 4A, in the mask of the present example, as indicated by using characters Y1 to Y6 in FIG. 4A, the ejecting position to increase the ejection amount of ink and the number of stages to increase the ejection amount are specified for a preset number of ejecting positions aligned in the main scanning direction. On the other hand, at the time of the main scan, it is usually considered that the ink is ejected to more ejecting positions than the ejecting positions aligned in the main scanning direction in the mask. Therefore, in the present example, in the case of applying the mask, for example, the mask is applied to the respective ejecting positions to eject ink at the time of each main scan by periodically applying the mask with respect to the main scanning direction. In addition, when performing the recovery process using such a mask, the operation of the controller 30 (see FIG. 1A), for example, can be considered as an operation for causing the adjacent nozzle to eject ink of a larger amount than that in the normal time to a part of the ejecting positions where the ink can be ejected at the time of the main scan by the nozzle adjacent to the abnormal nozzle based on the mask described above. In this case, the nozzle adjacent to the abnormal nozzle is an example of another nozzle in the vicinity of the abnormal nozzle. Furthermore, in this case, the volume of the ink to be ejected is made larger than the normal time for a part of ejecting positions where ink is ejected by the nozzle adjacent to the abnormal nozzle by increasing the ejection amount according to the number of stages specified in the mask. Furthermore, the manner of applying the mask, for example, can be considered as an operation of periodically applying a mask for each size (preset number mentioned above) of the mask in the main scanning direction with respect to the arrangement of ejecting positions where ink is ejected by the nozzles adjacent to the abnormal nozzle.

FIGS. 4B and 4C show an example of the application result of a mask. FIG. 4B is a view showing the volume of ink to be ejected to each ejecting position before application of the mask, and shows an example of the volume of ink to be ejected to the ejecting positions indicated by characters N1 to N6 in FIG. 4B for three consecutive nozzles indicated by characters L2 to L4 in FIG. 4B (three nozzles continuously arranged in the nozzle row direction). The contents shown in FIG. 4B can be considered as, for example, part of data (image data) indicating an image before application of the mask. Furthermore, in FIG. 4B, the volume of ink specified for each ejecting position is the volume of ink when there is no abnormal nozzle in the above three nozzles. Furthermore, the ejecting positions indicated by the characters N1 to N6 are a part of the ejecting positions in one main scan. Moreover, FIG. 4C is a view showing the volume of ink to be ejected to each ejecting position after application of the mask, and shows the result of applying the mask shown in FIG. 4A for a case in which the nozzle indicated by the character L3 is an abnormal nozzle, and the volume of ink at each ejecting position is set as shown in FIG. 4B. The contents shown in FIG. 4C can be considered as, for example, part of data (recovery data) indicating an image in a state after the recovery process has been performed.

Here, the description has been omitted above, but in the present example, when applying the mask, the contents of the mask are not reflected on all the ejecting positions, and the contents of the mask are reflected in accordance with the original ejecting position by the abnormal nozzle. In this case, the original ejecting position by the abnormal nozzle is, for example, a position where the ink should have been ejected when the abnormal nozzle is a normal nozzle. Furthermore, in the case shown in FIG. 4B, among the ejecting positions corresponding to the nozzle indicated by the character L3, the ejecting positions indicated by the characters N2, N3, N5, and N6 are the original ejecting positions. Then, in this case, the contents of the mask are reflected only on the ejecting position adjacent in the nozzle row direction to the original ejecting position by the abnormal nozzle, and the ejection amount of the ink is increased. In this case, to increase the ejection amount of ink by reflecting the contents of the mask means, for example, to increase the ejection amount of ink when a value greater than or equal to one is set as the value corresponding to the relevant ejecting position in the mask. More specifically, when an abnormal nozzle is present, for example, the controller 30 sets the amount of ink to be ejected to be larger than that in the normal time based on the mask, only with respect to the ejecting position adjacent in the nozzle row direction and only with respect to the ejecting position where ink is ejected when the abnormal nozzle is a normal nozzle, among the ejecting positions where the nozzles adjacent to the abnormal nozzle eject ink.

Furthermore, in the case shown in FIG. 4B, as described above, among the ejecting positions corresponding to the nozzle indicated by the character L3 which is the abnormal nozzle, the ejecting positions indicated by the characters N2, N3, N5 and N6 become the original ejecting positions. Therefore, only the ejecting positions indicated by the characters N2, N3, N5, and N6 are the ejecting positions whose values are changed by the mask even for the ejecting positions corresponding to the nozzles indicated by the characters L1 and L3, which are nozzles adjacent to the abnormal nozzle. Therefore, as shown in FIG. 4B, for example, the volume of ink does not change between before and after the application of the mask for the ejecting positions corresponding to the characters N1 and N4 among the ejecting positions corresponding to the nozzle indicated by the character L2.

In this regard, when applying the mask, the result of performing an excessive recovery process may be obtained by performing a uniform recovery process when the original ejecting position by the abnormal nozzle is not taken into consideration, for example, even when printing an image in which printing is performed with hardly using the nozzle corresponding to the abnormal nozzle. On the other hand, in the present example, the amount of ink to be ejected is not changed even if it is specified to increase the amount of ink in the mask with respect to the ejecting position adjacent in the nozzle row direction to the ejecting position where ink is not ejected even when the abnormal nozzle is a normal nozzle. Therefore, according to the present example, for example, the recovery process can be performed in accordance with the number of original ejecting positions in the abnormal nozzle. Furthermore, for example, this makes it possible to appropriately prevent excessive recovery process from being performed, and more appropriately perform the recovery process in accordance with the image to be printed.

As described above, according to the present example, for example, with respect to a part of the ejecting position where ink can be ejected at the time of the main scan by the nozzle adjacent to the abnormal nozzle based on the mask, a larger amount of liquid than the normal time can be ejected. Thus, for example, the recovery process performed using a mask can be appropriately performed. Furthermore, in this case, the recovery process can be easily and appropriately performed without performing many calculations, and the like by specifying the ejecting position to increase the ejection amount of ink by other nozzles other than the abnormal nozzle and the ejection amount (increase amount of ink) to be increased at such an ejecting position in the mask. Therefore, according to this example, when an abnormal nozzle is present, the influence of the presence of the abnormal nozzle can be appropriately suppressed.

In a case of printing an image or the like, it is conceivable that the extent to which the recovery process is preferably performed differs depending on the printing conditions and the image to be printed. On the other hand, in the present example, as described above, the mask storage 22 (see FIG. 1A) of the printing apparatus 10 is used to store a plurality of masks different from each other. With this configuration, for example, a mask can be selected from among a plurality of masks prepared in advance, according to the printing conditions and the image to be printed. Furthermore, in this case, the recovery process is executed based on any mask selected from the plurality of masks. More specifically, in this case, it is conceivable to use, for example, masks having different correction intensities as the plurality of masks. The difference in correction intensity means that, for example, the amounts of ink to be increased with respect to other nozzles in the vicinity of the abnormal nozzle are different from each other. Furthermore, in this case, the amount of ink to be increased can be considered as, for example, an amount corresponding to the total of the number of stages specified as an amount to increase the ejection amount of the ink in the mask.

In this case, the mask selection may be performed automatically or manually by a user. In the case of automatically selecting a mask, for example, it is conceivable to select the mask based on the image density of the image to be printed. In this case, the image density is, for example, the color strength in the image to be printed. The image density can also be considered as, for example, a concentration corresponding to the density of ink dots formed on the medium at the time of printing. Furthermore, in this case, as the plurality of masks stored by the mask storage 22, for example, it is conceivable to use a plurality of masks each associated with different image densities. In this case, at the time of execution of the recovery process, the controller 30 (see FIG. 1A) of the printing apparatus 10 selects any mask from the plurality of masks based on, for example, the image density of the image to be printed. Then, recovery process is executed based on the selected mask. With this configuration, for example, the recovery process can be more appropriately performed in accordance with the image to be printed. In addition, when selecting the mask manually, for example, it is conceivable to check the result of actually performing the printing and change the mask as necessary.

When printing is performed through the inkjet method as in the printing apparatus 10 of the present example, normally, a raster image is generated as image data indicating an image to be printed by performing RIP process or the like. Generating a raster image by performing RIP process and the like means, for example, generating a raster image indicating the ink ejecting position at a resolution that matches the resolution of printing by performing a separation process according to the number of colors of ink to be used for printing, conversion of resolution according to the printing resolution, halftone process and the like. Furthermore, as such a raster image, consideration is made to generate a raster image that is the same as or similar to that at the time of printing with a known inkjet printer. In the present example, the mask described above is applied to, for example, a raster image generated in this manner. In this case, the recovery process can be considered, for example, as an operation of correcting a raster image indicating the ink ejecting position.

More specifically, in this case, the controller 30 causes the respective nozzles of each of the inkjet heads in the head portion 12 (see FIG. 1A) to eject the ink, for example, based on the raster image indicating the ejecting position of the ink. Furthermore, when an abnormal nozzle is present, the controller 30 corrects the raster image based on the mask, for example, to cause each nozzle to eject ink based on the corrected raster image. Moreover, for example, the recovery process is executed by changing the ejection amount of ink by the nozzle adjacent to the abnormal nozzle at the time of the main scan. According to such a configuration, for example, the recovery process using a mask can be appropriately performed.

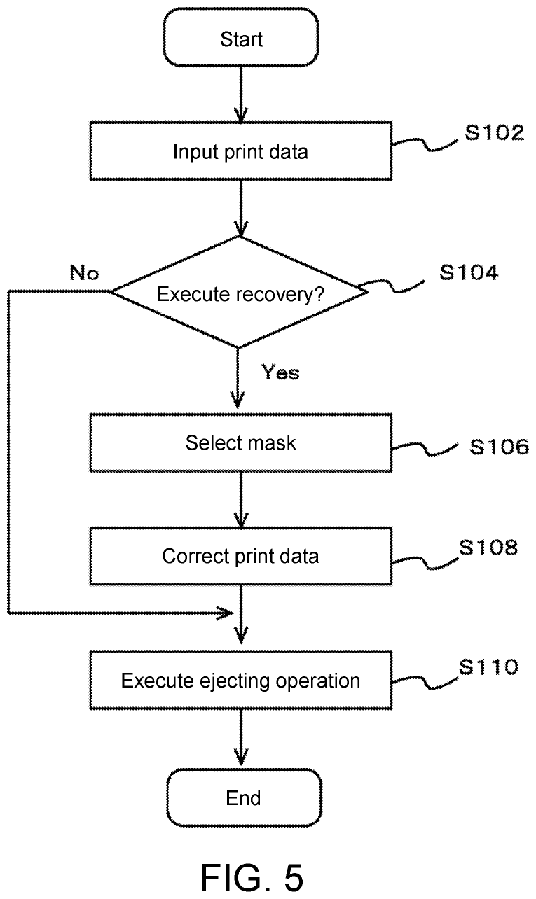

Next, the printing operation performed by the printing apparatus 10 of the present example will be described in more detail. FIG. 5 is a flowchart showing an example of the printing operation performed by the printing apparatus 10. In the printing apparatus 10 of the present example, when the printing operation is performed, print data indicating an image to be printed is first input (S102). It is conceivable to input the data of the raster image described above, for example, as the print data. In this case, for example, a host PC or the like that controls the operation of the printing apparatus 10 performs the RIP process and the like to generate a raster image. Furthermore, in a modified example of the operation of the printing apparatus 10, data before the RIP process or the like is performed may be input as the print data. In this case, for example, the controller 30 of the printing apparatus 10 performs the RIP process and the like to generate the raster image.

Furthermore, after the input of print data, whether or not an abnormal nozzle is present is checked based on, for example, information of the abnormal nozzle stored in advance. Moreover, whether or not perform the recovery process is determined (S104). When an abnormal nozzle is present and recovery process is to be performed (S104: Yes), a mask used for the recovery process is selected from the plurality of masks stored in the mask storage 22 (S106). In this case, the mask may be selected automatically or manually by the user, as described above.

Then, after selecting the mask, the mask is applied to the print data indicating the raster image, so that the print data is corrected to make the volume of ink to be ejected by the nozzle adjacent to the abnormal nozzle larger than that in the normal time without using the abnormal nozzle (S108). Then, the main scan or the like is performed based on the corrected print data to execute the ejecting operation of ejecting the ink from each nozzle of each inkjet head (S110). When determined in step S104 that the abnormal nozzle is not present and the recovery process is not to be performed (S104: No), the process proceeds to step S110, and the ejecting operation is executed. According to the present example, the image indicated by the print data can be appropriately printed by the above operations. Furthermore, the recovery process can be appropriately performed in a case where an abnormal nozzle is present.

Next, supplementary description regarding each configuration described above, description on a modified example, and the like will be made. As described above, according to the present example, the recovery process when an abnormal nozzle is present can be appropriately performed. Furthermore, regarding this point, as a recovery process when an abnormal nozzle is present, a recovery process using an operation through a multi-pass method, and the like has been widely performed conventionally. In this case, the multi-pass method is, for example, a method in which the main scan is performed such that a plurality of main scans are performed on each position of the medium which is an ink ejecting target. In this case, the nozzles which can eject ink to one position can be differed for each main scan by performing the sub scan between the main scans. Therefore, even when an abnormal nozzle is present, the recovery process can be performed by an alternative process of ejecting ink using another nozzle in another main scan with respect to the ejecting position corresponding to the abnormal nozzle in each main scan.

However, when printing is performed by a one-pass operation, such an alternative process of the nozzle cannot be performed, and thus the recovery process cannot be performed through such a method. On the other hand, in the present example, the recovery process can be performed in one main scan using a nozzle in the vicinity of the abnormal nozzle. Therefore, according to the present example, even when printing is performed by a one-pass operation, the recovery process can be appropriately performed.

Furthermore, as described above, in the present example, the printing apparatus 10 is a textile printer that uses a cloth medium as an ink ejecting target. In this case, as the ink permeates the medium, the ink dots easily spread on the medium. As a result, the ink dots become large, and the recovery process can be more appropriately performed. However, in the modified example of the printing apparatus 10, printing may be performed on a medium other than fabric. In this case as well, the ink is preferably ejected from the inkjet head so that an ink dot, which is large to a certain extent, is formed at the time of the main scan.

Moreover, when printing on fabric and the like, it is also conceivable to use, for example, a method of transferring using a transfer medium, other than the direct printing method of directly printing on a medium. In this case, in the printing apparatus 10, a transfer medium is used as an ink ejecting target. Then, after an image is printed on a transfer medium, the image is transferred to a medium such as fabric to complete an image (image after transfer), which becomes a final product. In this case, a sublimation transfer ink which is a sublimation ink used for transfer can be suitably used as the ink. In this case, since the ink dots spread during sublimation transfer of transferring the image from the transfer medium to another medium, the ink dots constituting the image after transfer, which becomes the final product, tend to be large dots. Therefore, even in such a case, the effect of the recovery process performed using the mask can be appropriately enhanced.

Furthermore, as described above, in the present example, the mask storage 22 stores a plurality of masks different from each other. Moreover, it is conceivable to use, for example, a plurality of masks each associated with different image densities as the plurality of masks. In this case, more specifically, for example, it is preferable to use a plurality of masks corresponding to a plurality of image densities including at least a low image density of less than or equal to 20%, an intermediate image density of about 40 to 60%, and a high image density of greater than or equal to 80% such as an image density of 20%, 40%, 60%, 80% and 100%. Furthermore, at the time of the execution of the recovery process, for example, it is conceivable to select one mask for one image based on, for example, the image density in the entire image to be printed. In this case, the image density in the entire image is, for example, the average image density in the entire image. Further, in order to perform a more accurate recovery process, a plurality of masks may be selected for one image, and the masks may be switched for each part of the image. In this case, for example, it is conceivable to select a mask corresponding to each part according to the image density of each part of the image. Furthermore, in this case, it is conceivable to use a line drawn by one nozzle in one main scan as each part of the image. In this case, the line drawn by one nozzle is, for example, a line which should have been drawn when the abnormal nozzle is a normal nozzle. Alternatively, the image density may be calculated for each part of a preset length in one line, not for the entire line, and the mask may be switched for each part. With this configuration, for example, the recovery process with higher accuracy can be appropriately performed.

Furthermore, in the above description, a case where the operation in one pass is performed has been mainly described regarding the operation of the printing apparatus 10. However, in a modified example of the printing apparatus 10, for example, printing through a multi-pass method may be performed. In this case as well, the recovery process can be appropriately performed using the mask in the same or similar manner as described above. Moreover, when printing through a multi-pass method is performed, it is conceivable to use, for example, an ultraviolet-curable ink and the like, which cures by irradiation of an ultraviolet-ray as an ink. In such a case, it is considered preferable to perform the recovery process through the method of the present embodiment, instead of the conventional recovery process using the operation through the multi-path method. More specifically, for example, when the operation of ejecting ink in place of the abnormal nozzle is performed in another main scan as in the recovery process performed using the operation through the multi-pass method, a change may occur also in the timing at which the ink lands. In addition, in the case of using the ultraviolet-curable ink, when a change occurs in the landing timing, an unintended stripe or the like may be generated due to an influence that a difference occurs in the curing timing between the ultraviolet-curable ink and the surrounding ink. In the case of using the ultraviolet-curable ink, in order to prevent the occurrence of such stripes and the like, for example, even if the printing operation itself is performed through the multi-pass method, the recovery process is preferably performed in the same main scan. Therefore, in the case of using the ultraviolet-curable ink, it is particularly preferable to perform the recovery process as in the present example.

Furthermore, as described above, in the present example, the printing apparatus 10 performs the printing operation through the serial method. However, in the modified example of the printing apparatus 10, the printing apparatus 10 may perform the printing operation through the line method. In this case, the printing operation through the line method is, for example, an operation of performing printing using an inkjet head capable of simultaneously ejecting ink to the entire width direction of the printing range in a medium. Furthermore, the printing operation through the line method can also be considered as, for example, an operation in which printing is performed by performing only the scanning operation corresponding to the main scan, instead of performing the main scan and the sub scan. In this case, for example, the operation of ejecting ink from the inkjet head while moving the inkjet head relative to the medium by conveying the medium can be considered as an example of the main scan.

Furthermore, various modified examples may be considered the configuration of the printing apparatus 10 and the like. More specifically, for example, a part of the process performed by the controller 30 of the printing apparatus 10 may be performed by a computer or the like external to the printing apparatus 10. Furthermore, it is also conceivable to use a storage device external to the printing apparatus 10 as the mask storage 22. In these cases, the printing system including the device external to the printing apparatus 10 can be considered as an example of the liquid ejecting device.

Furthermore, as described above, in the present example, the printing apparatus 10 is an inkjet printer that draws a two-dimensional image on the medium by ejecting the ink to the medium. However, in the modified example of the printing apparatus 10, it is also conceivable to use, as the printing apparatus 10, a 3D printer (3D printing apparatus, shaping device) or the like that shapes a stereoscopic shaped object. Furthermore, in this case, a shaping table that supports a shaped object being shaped and a shaped object being shaped can be considered as objects to which the ink is to be ejected. In this case as well, the influence of the presence of an abnormal nozzle can be more appropriately suppressed by performing the recovery process in the same manner as described above. Furthermore, in this case, the 3D printer can be considered as an example of the liquid ejecting device.

### INDUSTRIAL APPLICABILITY

The present disclosure can be suitably used in, for example, a printing apparatus.

What is claimed is:

1. A liquid ejecting device that ejects a liquid through an inkjet method, and the liquid ejecting device comprising:
an inkjet head including a plurality of nozzles arranged with positions shifted from each other in a nozzle row direction that is predetermined;
a scanning driver that causes the inkjet head to perform a main scan of ejecting the liquid while relatively moving in a main scanning direction intersecting the nozzle row direction with respect to an liquid ejecting target; and
a controller that controls operation of the inkjet head and the scanning driver,
wherein when an abnormal nozzle which is a nozzle having an abnormal ejection characteristic is present, the controller causes another nozzle in a vicinity of the abnormal nozzle to eject the liquid of a larger amount than that in a normal time when the abnormal nozzle is not present to a part of an ejecting position where the liquid is ejectable by the other nozzle in the main scan based on a mask prepared in advance, so that an amount of the liquid to be ejected at a time of the main scan by the other nozzle becomes larger than that in the normal time, and
the mask being data specifying the ejecting position for increasing an ejection amount of the liquid and an ejection amount to be increased at the ejecting position.

2. The liquid ejecting device according to claim 1, wherein
when the abnormal nozzle is present, in the main scan, the controller does not cause the abnormal nozzle to eject the liquid and causes the other nozzle to eject the liquid of the larger amount than that in the normal time to the part of the ejecting position where the liquid is ejectable by the other nozzle.

3. The liquid ejecting device according to claim 1, wherein
the inkjet head changes a volume of the liquid to be ejected from the nozzle in a plurality of stages; and
the mask specifies a number of stages for increasing the ejection amount as an ejection amount to be increased at an ejecting position where an ejection amount of the liquid is to be increased.

4. The liquid ejecting device according to claim 3, wherein
at least an adjacent nozzle adjacent to the abnormal nozzle in the nozzle row direction is used as the other nozzle,
the mask specifies, for a preset number of ejecting positions aligned in the main scanning direction, an ejecting position for increasing the ejection amount of the liquid and a number of stages for increasing the ejection amount, and
when the abnormal nozzle is present, the controller periodically applies the mask for every preset number to an arrangement of ejecting positions for ejecting the liquid by the adjacent nozzle to cause the adjacent nozzle to eject the liquid of the larger amount than that in the normal time to the part of the ejecting position where the liquid is ejectable by the adjacent nozzle in the main scan.

5. The liquid ejecting device according to claim 1, wherein
at least an adjacent nozzle adjacent to the abnormal nozzle in the nozzle row direction is used as the other nozzle, and
when the abnormal nozzle is present, among ejecting positions where the liquid is to be ejected by the adjacent nozzle, the controller increases an amount of the liquid to be ejected than that in the normal time based on the mask, only with respect to an ejecting position adjacent in the nozzle row direction and only with respect to an ejecting position where the liquid is ejected when the abnormal nozzle is a normal nozzle.

6. The liquid ejecting device according to claim 1, wherein
the controller causes each of the nozzles of the inkjet head to eject the liquid based on a raster image indicating an ejecting position of the liquid, and
when the abnormal nozzle is present, the controller corrects the raster image based on the mask, and causes each of the nozzles to eject the liquid based on the raster image after being corrected, so as to cause the other nozzle to eject the liquid of the larger amount than that in the normal time to the part of the ejecting position where the liquid is ejectable by the other nozzle in the main scan.

7. The liquid ejecting device according to claim 1, wherein
the scanning driver causes the inkjet head to perform the main scan, so as to perform one main scan with respect to each position of the liquid ejecting target.

8. The liquid ejecting device according to claim 1, wherein
the liquid ejecting device is a printing apparatus that uses a cloth medium as the liquid ejecting target,
the liquid is an ink used for printing, and
in the main scan, the inkjet head ejects ink from each of the nozzles, so that ink dots formed on the cloth medium by inks ejected from the nozzles adjacent in the nozzle row direction have a size of coming into contact on the cloth medium.

9. The liquid ejecting device according to claim 1, wherein
the liquid is a sublimation transfer ink, and
the liquid ejecting device is a printing apparatus that uses a transfer medium as an ejecting target of the sublimation transfer ink.

10. The liquid ejecting device according to claim 1, wherein
the liquid is an ultraviolet-curable ink that is cured by irradiation of an ultraviolet light.

11. The liquid ejecting device according to claim 1, further comprising:
a mask storage that stores a plurality of masks different from each other,
wherein when the abnormal nozzle is present, the controller causes the other nozzle to eject the liquid of the larger amount than that in the normal time to the part of the ejecting position where the liquid is ejectable by the other nozzle in the main scan based on any of the masks selected from the plurality of masks.

12. The liquid ejecting device according to claim 11, wherein
the liquid ejecting device is a printing apparatus that prints an image,
the liquid is an ink used for printing,
the mask storage stores the plurality of masks associated with image densities different from each other, and
when the abnormal nozzle is present, the controller selects any of the masks from the plurality of masks based on the image density of an image to be printed, and causes the other nozzle to eject the liquid of the larger amount than that in the normal time to the part of the ejecting position where the liquid is ejectable by the other nozzle in the main scan based on the mask that is selected.

13. A liquid ejecting method that ejects a liquid through an inkjet method, and the liquid ejecting method comprising:
providing an inkjet head, including a plurality of nozzles arranged with positions shifted from each other in a nozzle row direction that is predetermined; and
causing the inkjet head to perform a main scan of ejecting the liquid while relatively moving in a main scanning direction intersecting the nozzle row direction to an liquid ejecting target;
wherein in a control of the main scan,
when an abnormal nozzle which is a nozzle having an abnormal ejection characteristic is present,
causing another nozzle in a vicinity of the abnormal nozzle to eject the liquid of a larger amount than that in a normal time when the abnormal nozzle is not present to a part of an ejecting position where the liquid is ejectable by the other nozzle in the main scan based on a mask prepared in advance, so that an amount of the liquid to be ejected at a time of the main scan by the other nozzle becomes larger than that in the normal time, and
the mask being data specifying the ejecting position for increasing an ejection amount of the liquid and an ejection amount to be increased at the ejecting position.
